(19) United States
(12) Patent Application Publication
(10) Pub. No.: US 2026/0188644 A1
(43) Pub. Date: Jul. 2, 2026

(54) ALKALINE DRY BATTERY

(71) Applicant: Panasonic Intellectual Property Management Co., Ltd., Kadoma-shi, Osaka (JP)

(72) Inventors: Yasufumi Takahashi, HYOGO KEN (JP); Masanobu Takeuchi, HYOGO KEN (JP)

(73) Assignee: Panasonic Intellectual Property Management Co., Ltd., Kadoma-shi, Osaka (JP)

(21) Appl. No.: 18/867,996

(22) PCT Filed: May 15, 2023
(86) PCT No.: PCT/JP2023/018152

§ 371 Date: Nov. 21, 2024

(30) Foreign Application Priority Data
May 24, 2022 (JP) 2022-084373

(51) Int. Cl. H01M 4/12; H01M 4/02; H01M 6/06

(52) U.S. Cl. CPC H01M 4/12; H01M 6/06; H01M 2004/021; H01M 2004/027

(57) ABSTRACT

An alkaline dry battery including a negative electrode containing a zinc alloy powder. The zinc alloy powder contains first, second, and third zinc alloy particles. In a cross-sectional image of the zinc alloy powder, the first zinc alloy particles each include a specific hole, the second zinc alloy particles each do not include the hole but include a specific closed void therein, and the third zinc alloy particles each do not include the hole and the void therein. The hole is a hole for which a ratio D/W between a straight-line distance D from an opening to a bottom surface and a width W of the opening is 1.0 or more, and the straight-line distance D is 2 μm or more. The void has a minor axis length of 2 μm or more. The zinc alloy powder has an apparent density within a range from 6.980 to 7.050 g/cm³.

### TECHNICAL FIELD

The present disclosure relates to an alkaline dry battery.

### BACKGROUND ART

Alkaline dry batteries (alkaline manganese dry batteries) are widely used because a large current can be taken therefrom due to their capacities larger than capacities of manganese dry batteries. Various zinc particles and zinc alloy particles have been proposed as negative electrode active materials for alkaline dry batteries.

PTL 1 (JP H05-299087A) discloses “a mercury-free zinc alloy powder for alkaline batteries characterized by being constituted of zinc containing bismuth in an amount of 0.01 to 0.5% by weight, indium in an amount of 0.01 to 0.5% by weight, and the balance including iron as an accompanying impurity in an amount of 1 ppm or less, and having a true specific gravity of 6.4 g/cm³ or more”.

PTL 2 (JP S60 (1985)-56367A) discloses “an alkaline battery including a zinc powder as a negative electrode active material, characterized in that at least a portion of the zinc powder is composed of particles having voids therein.”

PTL 3 (WO 2006/122628) discloses “an alloyed zinc powder for alkaline batteries including particles pierced with at least one hole in an amount of more than, either one or more, of: 10% by count in the sieving fraction 250 to 425 μm; 3% by count in the sieving fraction 150 to 250 μm; and 2% by count in the sieving fraction 105 to 150 μm.”

### CITATION LIST

### Patent Literature

PTL 1: JP H05-299087A
PTL 2: JP S60 (1985)-56367A
PTL 3: WO 2006/122628

### SUMMARY OF INVENTION

### Technical Problem

There is demand for further improving the safety of an alkaline dry battery by suppressing a temperature increase in the event of an external short circuit. Under the above circumstances, an object of the present disclosure is to provide an alkaline dry battery of which a temperature increase in the event of an external short circuit is small.

### Solution to Problem

An aspect of the present disclosure relates to an alkaline dry battery. The alkaline dry battery includes: a positive electrode; a negative electrode; and a separator disposed between the positive electrode and the negative electrode, wherein the negative electrode contains a zinc alloy powder, the zinc alloy powder contains first zinc alloy particles, second zinc alloy particles, and third zinc alloy particles, in a cross-sectional image of the zinc alloy powder, the first zinc alloy particles each include a specific hole, the second zinc alloy particles each do not include the specific hole but include a specific closed void therein, the third zinc alloy particles each do not include the specific hole and the specific closed void therein, the specific hole is a hole for which a ratio D/W between a straight-line distance D from an opening to a bottom surface and a width W of the opening is 1.0 or more, and the straight-line distance D is 2 μm or more, and the specific closed void has a minor axis length of 2 μm or more, and the zinc alloy powder has an apparent density within a range from 6.980 to 7.050 g/cm³.

### Advantageous Effects of Invention

According to the present disclosure, it is possible to suppress a temperature increase of an alkaline dry battery in the event of an external short circuit.

Although novel features of the present invention are described in the appended claims, the following detailed description referring to the drawings will further facilitate understanding of both the configuration and the content of the present invention as well as other objects and features of the present invention.

### BRIEF DESCRIPTION OF DRAWINGS

FIG. 1A is a schematic diagram for describing a classification method for a zinc alloy powder.

FIG. 1B is another schematic diagram for describing the classification method for a zinc alloy powder.

FIG. 2 is a front view of an alkaline dry battery according to an embodiment of the present disclosure, showing a cross section of a portion of the alkaline dry battery.

### DESCRIPTION OF EMBODIMENTS

The following describes example embodiments according to the present disclosure, but the present disclosure is not limited to the following examples. In the following description, specific numerical values and materials are described as examples, but other numerical values and materials may be applied as long as the invention according to the present disclosure can be implemented. In the present specification, the wording “from a numerical value A to a numerical value B” refers to a range that includes the numerical values A and B, and can be read as “the numerical value A or more and the numerical value B or less”. In the following description, if lower and upper limits of numerical values regarding specific physical properties or conditions are exemplified, any of the exemplified lower limits and any of the exemplified upper limits can be combined as desired as long as the lower limit is not equal to or greater than the upper limit.

### (Alkaline Dry Battery)

An alkaline dry battery according to the present embodiment may be hereinafter referred to as an “alkaline dry battery (A)”. The alkaline dry battery (A) includes a positive electrode, a negative electrode, and a separator disposed between the positive electrode and the negative electrode. The negative electrode contains a zinc alloy powder.

The zinc alloy powder contains first zinc alloy particles, second zinc alloy particles, and third zinc alloy particles. In a cross-sectional image of the zinc alloy powder, zinc alloy powder particles are classified as follows.

(1) The first zinc alloy particles are particles that each include a specific hole (hereinafter may also be referred to as a “hole H”). The specific hole His a hole for which a ratio D/W between a straight-line distance D from an opening to a bottom surface and a width W of the opening is 1.0 or more, and the straight-line distance D is 2 μm or more.
(2) The second zinc alloy particles are particles that each do not include the specific hole H but include a specific closed void (hereinafter may also be referred to as a “specific void V” or a “void V”) therein. The specific void V has a minor axis length of 2 μm or more.
(3) The third zinc alloy particles are particles that each do not include the specific hole H and the specific void V therein.

The above-described zinc alloy powder has an apparent density within a range from 6.980 to 7.050 g/cm³. Here, the apparent density is defined as a value (g/cm³) obtained by dividing the mass (g) of a sample by an apparent volume of the sample (the apparent volume is a volume (cm³) obtained by excluding open pores from an outer volume of the sample) as defined in JIS R 1634-1998 (method for measuring density of fine ceramics). That is to say, the apparent density is a density calculated in a manner in which the volume of the particles includes closed voids inside the particles and does not include holes exposed at the surfaces of the particles. A density calculated in this manner is generally called “apparent density” irrespective of a measurement method used.

The apparent density of the zinc alloy powder can be measured using a gas displacement method, specifically, a method in accordance with the JIS Z 8807 standard. More specifically, the apparent density of the zinc alloy powder can be measured using a gas displacement pycnometer method in which helium gas is used.

Hereinafter, the first zinc alloy particles, the second zinc alloy particles, and the third zinc alloy particles may also be referred to as “first particles”, “second particles”, and “third particles”, respectively. Note that the state of the zinc alloy powder changes as the battery is used. Evaluation results of the zinc alloy powder (a ratio between the first through third particles, an average particle diameter, the apparent density, etc.) described in the present specification are evaluation results of the zinc alloy powder before the battery is used. Examples of the zinc alloy powder before the battery is used include the zinc alloy powder prior to being used in the negative electrode and the zinc alloy powder contained in the negative electrode of the battery prior to being used.

When an external short circuit occurs in the alkaline dry battery, i.e., when a short circuit occurs outside the alkaline dry battery between a positive electrode terminal and a negative electrode terminal of the battery, a large current flows through the battery and the temperature of the battery increases. Accordingly, in order to improve the safety of the battery, it is necessary to suppress the temperature increase of the battery when an external short circuit occurs in the battery.

The inventors of the present application newly found through studies that it is possible to remarkably suppress a temperature increase in the event of an external short circuit by using a negative electrode active material obtained by mixing multiple types of zinc alloy particles having mutually different shapes such that the apparent density falls within a predetermined range. The alkaline dry battery (A) according to the present disclosure is based on this new finding.

Reasons why the temperature increase of the battery can be suppressed with this configuration of the alkaline dry battery (A) in the event of an external short circuit are not clear at present. However, the following reasons are conceivable.

The first particles (first zinc alloy particles) have the hole H, and therefore have a large specific surface area and high reactivity. Accordingly, when an external short circuit occurs, the first particles react fiercely from right after the occurrence of the short circuit and increases the short-circuit current. Therefore, if the proportion of the first particles is too high, a large current is generated and the temperature of the battery significantly increases in an initial stage of the short circuit. On the other hand, when the first particles are contained in a small amount, a large current flows in the event of an external short circuit but passivation of the zinc alloy powder is promoted, and accordingly, the voltage decreases and the temperature increase of the battery stops early, and consequently an excessive temperature increase of the battery can be suppressed. The second particles (second zinc alloy particles) do not have the hole H on their surfaces, and accordingly, do not react fiercely right after the occurrence of a short circuit. Moreover, the second particles include the void V therein, and accordingly, when the second particles are contained in a small amount, the second particles can suppress heat generation in the event of an external short circuit more than the third particles, which do not include the void V. However, when the second particles are consumed due to the short circuit, the internal void V appears on their surfaces, a localized increase in the specific surface area occurs, and the second particles react fiercely. Therefore, if the proportion of the second particles is too high, the short-circuit current is unlikely to decrease, and consequently, generated heat is accumulated and the temperature of the battery keeps increasing.

For the reasons described above, it is conceivable that containing the first through third particles at appropriate proportions is effective in suppressing the temperature increase of the battery in the event of an external short circuit. It is thought that usually, not only the second particles but also some of the first particles include the void V therein. It is presumed that apparent densities of the first particles and the second particles both tend to be lower than the apparent density of the third particles in view of a reduction in the apparent densities according to the number or the size of voids formed in the particles and a reduction in the true specific gravities due to zinc oxide newly formed accompanying the formation of holes. Accordingly, it is presumed that when the apparent density of the zinc alloy powder falls within the range from 6.980 to 7.050 g/cm³, the first through third particles are contained at appropriate proportions, and consequently, the temperature increase of the battery in the event of an external short circuit is suppressed.

The apparent density of the zinc alloy powder is 6.980 g/cm³ or more, and may also be 7.010 g/cm³ or more, 7.020 g/cm³ or more, or 7.030 g/cm³ or more. The apparent density is 7.050 g/cm³ or less, and may also be 7.045 g/cm³ or less, 7.030 g/cm³ or less, or 7.020 g/cm³ or less. The apparent density is within the range from 6.980 to 7.050 g/cm³, and may also be within a range from 6.990 to 7.050 g/cm³, from 7.010 to 7.050 g/cm³, from 7.020 to 7.050 g/cm³, or from 7.030 to 7.050 g/cm³. In any of these ranges, the upper limit may be changed to 7.045 g/cm³, 7.030 g/cm³, or 7.020 g/cm³ unless the lower limit is greater than or equal to the upper limit. When the apparent density of the zinc alloy powder falls within a range from 7.010 to 7.045 g/cm³, the temperature increase of the battery in the event of an external short circuit can be suppressed particularly effectively.

A ratio Na/Nb between the number Na of the first zinc alloy particles and the number Nb of the second zinc alloy particles in the zinc alloy powder contained in the negative electrode is preferably within a range from 10/90 to 90/10.

The ratio Na/Nb in the zinc alloy powder contained in the negative electrode may be 10/90 or more, 30/70 or more, 45/55 or more, or 50/50 or more. The ratio Na/Nb may be 90/10 or less, 75/25 or less, 67/33 or less, 55/45 or less, or 50/50 or less. The ratio Na/Nb may be within a range from 10/90 to 90/10, from 30/70 to 90/10, from 45/55 to 90/10, or from 50/50 to 90/10. In any of these ranges, the upper limit may be changed to 75/25, 67/33, 55/45, or 50/50 unless the lower limit is greater than or equal to the upper limit.

A ratio Nc/Nt between the number Nc of the third zinc alloy particles and a sum Nt of the number Na, the number Nb, and the number Nc in the zinc alloy powder contained in the negative electrode may be more than 0 and 0.20 or less. By setting the ratio so as to fall within this range, it is possible to suppress the temperature increase of the battery in the event of an external short circuit. The ratio Nc/Nt may also be 0.02 or more, 0.04 or more, 0.10 or more, or 0.14 or more. The ratio Nc/Nt may also be 0.20 or less, 0.14 or less, or 0.10 or less. The ratio Nc/Nt may also be within a range from 0.02 to 0.20, from 0.04 to 0.20, from 0.10 to 0.20, or from 0.14 to 0.20. In these ranges, the upper limit may be changed to 0.14 or 0.10 unless the lower limit is greater than or equal to the upper limit.

It is preferable that, in the alkaline dry battery (A), the ratio Na/Nb falls within any of the above-listed ranges and the ratio Nc/Nt falls within any of the above-listed ranges.

The first through third particles may each independently have an average particle diameter of 30 μm or more, 50 μm or more, 70 μm or more, or 90 μm or more, and 200 μm or less, 150 μm or less, or 125 μm or less. Here, the average particle diameter is a median diameter (D50) at which an accumulated volume reaches 50% in a particle size distribution on the volume basis. The median diameter is determined using a dry process laser diffraction/scattering particle size distribution measuring device.

From the viewpoint of suppressing the temperature increase in the event of an external short circuit, the average particle diameter of the first particles, the average particle diameter of the second particles, the average particle diameter of the third particles, and an average particle diameter of the zinc alloy powder as a whole may each fall within a range from 30 to 200 μm, from 50 to 200 μm, from 70 to 200 μm, or from 90 to 200 μm. In any of these ranges, the upper limit may be changed to 150 μm or 125 μm.

### (Classification Method for Zinc Alloy Powder)

The following describes a method for classifying the zinc alloy powder. First, a cross-sectional image of the zinc alloy powder is obtained. The cross-sectional image is obtained as follows, for example. First, the zinc alloy powder is dispersed in a resin, and then the resin is cured to obtain a sample. Next, at least a portion of the inside of the sample is exposed to expose cross sections of zinc alloy powder particles. There is no limitation on the method for exposing the cross sections, and a known method (e.g., a cross section polisher method) may be used.

Next, an image of the exposed cross sections is captured with use of a scanning microscope or the like to obtain a cross-sectional image. At this time, the image is captured such that at least 100 particles can be counted as evaluation targets. Particles that have a maximum diameter of 10 μm or more in the cross-sectional image can be selected as the evaluation targets. Here, the maximum diameter is the maximum length of a straight line connecting two points on an outer edge of a particle. Next, 100 particles are selected as the evaluation targets in the cross-sectional image, and the particles in the cross-sectional image are classified in accordance with the following criteria.

### (1) First Particles (First Zinc Alloy Particles)

The first particles are particles that each include the specific hole H. The ratio D/W between the straight-line distance D from an opening to a bottom surface of the hole H and the width W of the opening is 1.0 or more. Furthermore, the straight-line distance D is 2 μm or more. Note that a particle that includes both the hole H and the void Vis classified into the first particles. An example of a hole that does not satisfy the above conditions is a depression that has a gentle slope.

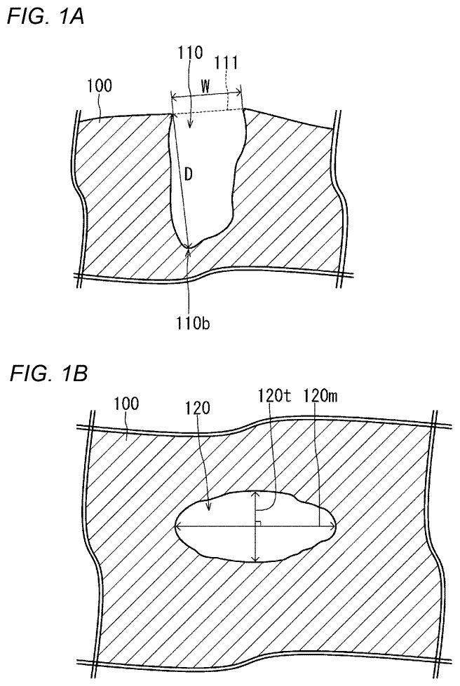

The following describes a method for determining the hole H with reference to the schematic diagram of FIG. 1A. Note that only a portion of a particle 100 is shown in FIGS. 1A and 1B. First, when a zinc alloy particle 100 includes a hole 110 in the cross-sectional image, an opening 111 of the hole is determined. Then, the width W of the opening 111 is calculated from the image. Next, a bottom surface 110b of the hole 110 is determined. The bottom surface 110b is a region of an inner surface of the hole 110 that is farthest from the opening 111. Then, the straight-line distance D (shortest distance) from the opening 111 to the bottom surface 110b is calculated from the image. Whether or not the particle 100 is a first particle is determined based on the calculated width W and straight-line distance D.

### (2) Second Particles (Second Zinc Alloy Particles)

When a particle that is an evaluation target is not a first particle, whether or not the particle is a second particle is determined. The second particles are particles that each do not include the specific hole H but include the specific void V therein. The void V has a minor axis length of 2 μm or more and is not exposed to the outside of the particle. The following describes a method for determining the void V with reference to the schematic diagram of FIG. 1B.

When there is a closed void 120 inside the zinc alloy particle 100, the minor axis length of the void 120 is determined. The minor axis length is the maximum value of a length 120t in a direction orthogonal to a longest axis 120m of the void 120 in the cross-sectional image of the particle. Whether or not the particle 100 is a second particle is determined based on the measured minor axis length.

### (3) Third Particles (Third Zinc Alloy Particles)

When a particle that is an evaluation target is neither a first particle nor a second particle, it is determined that the particle is a third particle. That is to say, all particles that are to be evaluated are classified into any of the first through third particles.

In the present specification, the ratio between the first through third particles (ratio between the numbers of respective particles) can be read as a ratio obtained by classifying zinc alloy particles having a maximum diameter of 10 μm or more. However, if the zinc alloy powder (first through third particles) has an average particle diameter of 10 μm or more, a classification result obtained by evaluating zinc alloy particles having a maximum diameter of 10 μm or more can be taken to be a classification result of the zinc alloy powder as a whole.

When the zinc alloy powder contained in the negative electrode of the battery is to be evaluated, it is possible to evaluate the zinc alloy powder by disassembling the battery prior to being used (prior to being discharged) and taking out the zinc alloy powder from the negative electrode.

### (Method for Manufacturing Zinc Alloy Powder)

There is no limitation on the method for forming the zinc alloy powder, but a disc atomization method (centrifugal atomization method) is preferably used. It is possible to simultaneously manufacture the first particles, the second particles, and the third particles with use of the disc atomization method by selecting conditions. That is to say, it is possible to manufacture a zinc alloy powder containing the first particles, the second particles, and the third particles in a single manufacturing process with use of the disc atomization method.

Note that it is also possible to manufacture the desired zinc alloy powder by mixing a plurality of zinc alloy powders that differ from each other in the ratio between the first through third particles. For example, it is possible to manufacture the desired zinc alloy powder by mixing a zinc alloy powder mainly composed of the first particles, a zinc alloy powder mainly composed of the second particles, and a zinc alloy powder mainly composed of the third particles. In this case, the zinc alloy powders may be manufactured using the same method or different methods. Each zinc alloy powder may be manufactured with use of the disc atomization method or another method. Examples of the method other than the disc atomization method include a gas atomization method and a hybrid atomization method that is a combination of the gas atomization method and the disc atomization method.

The following describes an example of the disc atomization method (centrifugal atomization method). First, a zinc alloy is melted to obtain a melt. Next, the melt of the zinc alloy is dripped onto a rotating disc as droplets in a chamber, and thus a zinc alloy powder can be obtained. The melt dripped onto the rotating disc is scattered toward a wall surface of the chamber and cooled to form the zinc alloy powder. In the process in which the melt is cooled and formed into particles on the disc and inside the chamber, the forms of the particles (the ratio between the numbers of the first through third particles and the apparent density of the zinc alloy powder) change depending on manufacturing conditions.

There is no particular limitation on the configuration of a device (e.g., the disc) used in the disc atomization method, and it is possible to apply a known device or modify a part of a known device.

The shapes of the particles (states of the formation of holes and voids) change when the dripping rate of the melt, the rotation speed of the disc, and the atmosphere in which the powder is manufactured (atmosphere in the chamber) are changed. By appropriately combining these conditions, it is possible to control the average particle diameter of particles to be formed, the ratio between the first through third particles, and the apparent density of the zinc alloy powder. As for the atmosphere in which the powder is manufactured, an oxygen concentration is important.

When the above-described zinc alloy powder is manufactured with use of the disc atomization method, it is preferable that at least one of the following conditions (1) to (3) is satisfied, and it is more preferable that two or all of the following conditions are satisfied.

(1) The dripping rate of the melt is within a range from 1.1 to 1.3 kg/minute.
(2) The rotation speed of the disc is within a range from 10,000 to 15,000 rpm.
(3) The oxygen concentration in the chamber is within a range from 10 to 15% by volume.

When the oxygen concentration in the chamber is reduced, the proportion of the third particles tends to increase, and accordingly, the apparent density of the zinc alloy powder tends to increase. The particle diameter of particles to be formed tends to increase when the rotation speed of the disc is reduced and the dripping rate of the melt is increased. The ratio Na/Nb tends to increase when the oxygen concentration in the chamber is increased. However, these tendencies are affected by other manufacturing conditions, and may not apply depending on other manufacturing conditions.

It is possible to manufacture particles having a high degree of sphericity by replacing the atmosphere in the chamber with an inert gas such as nitrogen to control the oxygen concentration to almost 0% by volume. On the other hand, it is possible to manufacture a zinc alloy powder containing the first through third particles and containing the first and second particles at high proportions by carrying out the disc atomization method in an atmosphere that has a higher oxygen concentration than an atmosphere in which a conventional disc atomization method is carried out. Furthermore, it is possible to control the ratio (ratio Na/Nb) between the number of the first particles and the number of the second particles by adjusting the dripping rate of the melt and the oxygen concentration.

The alkaline dry battery (A) includes the positive electrode, the negative electrode, the separator, and an electrolytic solution, and also includes other constituent elements as necessary. The following describes an example configuration of the alkaline dry battery (A). However, the configuration of the alkaline dry battery (A) is not limited to the following example. It is also possible to apply a known configuration as a configuration other than characteristic configurations of the alkaline dry battery (A).

### (Negative Electrode)

The negative electrode contains the above-described zinc alloy powder as a negative electrode active material. The zinc alloy is an alloy containing zinc and another metal element. At least one element selected from the group consisting of indium, bismuth, and aluminum may be contained as the other metal element. The indium content in the zinc alloy may be within a range from 0.01% by mass to 0.1% by mass. The bismuth content in the zinc alloy may be within a range from 0.003% by mass to 0.02% by mass. The aluminum content in the zinc alloy may be within a range from 0.001% by mass to 0.03% by mass. The content of elements other than zinc in the zinc alloy may be within a range from 0.025% by mass to 0.08% by mass from the viewpoint of corrosion resistance.

The first particles, the second particles, and the third particles typically have the same alloy composition, but may also have different alloy compositions. A configuration is also possible in which only two types of particles out of the first through third particles have the same alloy composition.

The negative electrode may also be a gel negative electrode. The gel negative electrode can be manufactured by mixing particles of the negative electrode active material, a gelling agent, and an alkaline electrolytic solution, for example. A known gelling agent that is used in the field of alkaline dry batteries may be used as the gelling agent. For example, a water-absorbing polymer or the like may be used as the gelling agent. Examples of the gelling agent include polyacrylic acid and sodium polyacrylate. The gelling agent may be used in an amount of 0.5 parts by mass to 2.5 parts by mass relative to 100 parts by mass of the negative electrode active material (zinc alloy powder).

A surfactant may also be added to the negative electrode to increase the reaction efficiency of the surface of the negative electrode active material. For example, a polyoxyalkylene group-containing compound, a phosphoric acid ester, or the like can be used as the surfactant. From the viewpoint of more uniformly distributing an additive in the negative electrode, it is preferable to add the additive in advance to an alkaline electrolytic solution to be used to manufacture the negative electrode.

In order to improve corrosion resistance, a compound that contains a metal having a high hydrogen overvoltage, such as indium or bismuth, may be added to the negative electrode as appropriate.

### (Negative Electrode Current Collector)

The alkaline dry battery (A) may also include a negative electrode current collector that is inserted into the negative electrode. The negative electrode current collector may be made of a metal (an elemental metal or an alloy). The material of the negative electrode current collector preferably contains copper and may also be an alloy (e.g., brass) containing copper and zinc. The negative electrode current collector may also be subjected to plating such as tin plating as necessary.

### (Positive Electrode)

There is no particular limitation on the positive electrode, and a known positive electrode may be used. The positive electrode contains manganese dioxide as a positive electrode active material. The positive electrode usually contains the positive electrode active material and a conductive agent, and further contains a binder as necessary. The positive electrode may be formed by pressure-molding a positive electrode mixture into a cylindrical body (positive electrode pellet). The positive electrode mixture contains the positive electrode active material, a conductive agent, and an alkaline electrolytic solution, for example, and further contains a binder as necessary. After the cylindrical body is housed in a case body, the cylindrical body may be pressed to come into intimate contact with an inner wall of the case body.

A preferred example of manganese dioxide used as the positive electrode active material is electrolytic manganese dioxide, but it is also possible to use natural manganese dioxide or chemical manganese dioxide. Examples of the crystal structure of the manganese dioxide include an α type, a β type, a γ type, a δ type, an ε type, an η type, a λ type, and a ramsdellite type.

The conductive agent may be a conductive carbon material. Examples of the conductive carbon material include carbon black (e.g., acetylene black) and graphite. Examples of the graphite include natural graphite and artificial graphite. A powder of the conductive agent may also be used.

In order to absorb hydrogen generated in the battery, a silver compound may also be added to the positive electrode. Examples of the silver compound include silver oxides (e.g., Ag₂O, AgO, Ag₂O₃) and a silver-nickel composite oxide (AgNiO₂).

### (Separator)

There is no particular limitation on the separator, and a known separator may be used. Examples of the separator include non-woven cloth and a microporous film. Examples of the material of the non-woven cloth include cellulose, polyvinyl alcohol, and polyolefin. The non-woven cloth may also be formed by mixing different fibers. Examples of the material of the microporous film include cellophane and polyolefin. The thickness of the separator may be within a range from 200 μm to 300 μm. It is also possible to use a plurality of separators superposed on each other.

### (Battery Housing)

There is no particular limitation on a battery housing, and it is sufficient to use a suitable housing according to the shape of the battery. The shape of the alkaline dry battery (A) is not particularly limited, and may be a cylindrical shape or a coin shape (including a button shape). The battery housing usually includes a battery case, a negative electrode terminal plate, and a gasket. A cylindrical metal case having a bottom is used as the battery case, for example. The metal case may be formed from a nickel-plated steel plate. In order to reduce contact resistance between the positive electrode and the battery case, an inner surface of the battery case may be covered with a carbon film. The negative electrode terminal plate can be formed from a material similar to the material of the metal case, and may be formed from a nickel-plated steel plate.

Examples of the material of the gasket include polyamide, polyethylene, and polypropylene. The gasket can be formed from any of these materials into a predetermined shape through injection molding, for example. Examples of the material of the gasket include polyamide-6,6, polyamide-6,10, polyamide-6,12, and polypropylene.

### (Alkaline Electrolytic Solution)

There is no particular limitation on the alkaline electrolytic solution, and a known alkaline electrolytic solution may be used. For example, an alkaline aqueous solution containing potassium hydroxide is used as the alkaline electrolytic solution. The concentration of potassium hydroxide in the alkaline electrolytic solution is preferably within a range from 30 to 50% by mass (e.g., from 30 to 40% by mass). The alkaline electrolytic solution may also contain lithium hydroxide (LiOH), sodium hydroxide (NaOH), cesium hydroxide (CsOH), rubidium hydroxide (RbOH), or the like.

The alkaline electrolytic solution may also contain a surfactant. It is possible to increase the efficiency of a reaction between the negative electrode active material particles and the electrolytic solution by using a surfactant. The above-listed examples of the surfactant that may be added to the negative electrode may be used, for example. The content of the surfactant in the alkaline electrolytic solution is usually within a range from 0 to 0.5% by mass (e.g., from 0 to 0.2% by mass).

### (Method for Manufacturing Alkaline Dry Battery)

There is no particular limitation on the method for manufacturing the alkaline dry battery (A) other than that the above-described zinc alloy powder is used, and a known manufacturing method may be applied. For example, a manufacturing method described in Examples may be used.

The following specifically describes an example embodiment according to the present disclosure with reference to the drawings. The above-described constituent elements can be applied to constituent elements of the following example. Also, the constituent elements of the following example can be changed based on the above description. Out of the constituent elements of the following example, constituent elements that are not essential to the alkaline dry battery (A) may be omitted. Also, matters described below may be applied to the above embodiment.

### Embodiment 1

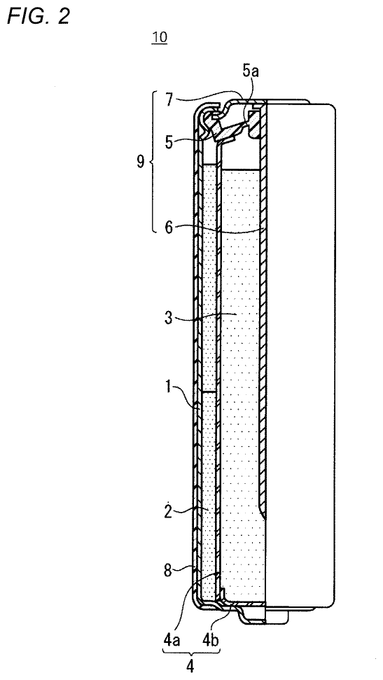

FIG. 2 is a partially exploded cross-sectional view of an alkaline dry battery 10 according to Embodiment 1. The alkaline dry battery 10 is a cylindrical battery and has an inside-out structure. The alkaline dry battery 10 includes a battery case 1, a positive electrode 2, a negative electrode (gel negative electrode) 3, a separator 4, a sealing unit 9, and an alkaline electrolytic solution (not shown). The positive electrode 2, the negative electrode 3, the separator 4, and the alkaline electrolytic solution are disposed inside the battery case 1 (battery housing). The negative electrode 3 contains the above-described zinc alloy powder.

The battery case 1 is a cylindrical case having a bottom and functions as a positive electrode terminal. The positive electrode 2 has a hollow cylindrical shape and is disposed so as to be in contact with an inner wall of the battery case 1. The negative electrode 3 is disposed in the hollow part of the positive electrode 2. The separator 4 is disposed between the positive electrode 2 and the negative electrode 3.

The separator 4 is composed of a cylindrical separator 4a and a bottom paper 4b. The separator 4a is disposed along an inner surface of the hollow part of the positive electrode 2 to separate the positive electrode 2 from the negative electrode 3. The bottom paper 4b is disposed at the bottom of the hollow part of the positive electrode 2 to separate the negative electrode 3 from the battery case 1.

An opening of the battery case 1 is sealed by the sealing unit 9. The sealing unit 9 includes a gasket 5, a negative electrode current collector 6, and a negative electrode terminal plate 7. The negative electrode terminal plate 7 functions as a negative electrode terminal. The negative electrode current collector 6 has a nail shape including a head portion and a body portion. The body portion of the negative electrode current collector 6 is inserted through a through hole provided in a center part of the gasket 5 and also inserted into the negative electrode 3. The head portion of the negative electrode current collector 6 is welded to a flat part at the center of the negative electrode terminal plate 7.

An opening edge portion of the battery case 1 is swaged onto a peripheral edge portion (flange portion) of the negative electrode terminal plate 7 via a peripheral edge portion of the gasket 5. An outer surface of the battery case 1 is covered with an exterior label 8. The battery case 1, the gasket 5, and the negative electrode terminal plate 7 constitute a battery housing.

### EXAMPLES

The following specifically describes the present disclosure based on examples, but the present disclosure is not limited to the following examples. In the following examples, a plurality of alkaline dry batteries that differ from each other in the negative electrode were manufactured and evaluated.

### (Battery A1)

A cylindrical AA alkaline dry battery (LR6) having the shape shown in FIG. 2 was manufactured as described below.

### (1) Manufacture of Positive Electrode

A graphite powder (conductive agent, average particle diameter: 8 μm) was added to an electrolytic manganese dioxide powder to obtain a mixture. The mass ratio between the electrolytic manganese dioxide powder and the graphite powder (electrolytic manganese dioxide powder: graphite powder) was 92.4:7.6. 1.5 parts by mass of an electrolytic solution was added to 100 parts by mass of the obtained mixture, the mixture was sufficiently stirred, and then formed into flakes by being compressed to obtain a positive electrode mixture. An alkaline aqueous solution containing potassium hydroxide and zinc oxide was used as the electrolytic solution. The alkaline aqueous solution contained potassium hydroxide at a concentration of 35% by mass and zinc oxide at a concentration of 2% by mass.

The flakes of the positive electrode mixture were pulverized to granules and the granules were classified using 10 to 100-mesh sieves. The classified granules were pressure-molded into a predetermined hollow cylindrical shape, and thus two positive electrode pellets (positive electrode) were manufactured.

### (2) Manufacture of Negative Electrode

A zinc alloy powder was manufactured with use of a disc atomization method. Specifically, a zinc alloy was melted to obtain a melt. The zinc alloy contained 0.02% by mass of indium, 0.01% by mass of bismuth, and 0.005% by mass of aluminum.

Next, the melt of the zinc alloy was dripped onto a rotating disc in an atmosphere containing oxygen at a concentration of 10% by volume. Thus, the zinc alloy powder was obtained. The dripping rate of the melt of the zinc alloy was 1.1 kg/minute. The rotation speed of the disc was 10,000 rpm. The obtained zinc alloy powder was evaluated using a method described below.

The obtained zinc alloy powder (negative electrode active material), an electrolytic solution, and a gelling agent were mixed to obtain a gel negative electrode. The same electrolytic solution as that used in the manufacture of the positive electrode pellets was used. A mixture of a crosslinked branched polyacrylic acid and a highly crosslinked chain sodium polyacrylate was used as the gelling agent. The mass ratio between the zinc alloy powder, the electrolytic solution, and the gelling agent (zinc alloy powder: electrolytic solution: gelling agent) was 100:50:1.

### (3) Assembly of Alkaline Dry Battery

First, a carbon film (thickness: about 10 μm) was formed on an inner surface of a cylindrical case (outer diameter: 13.80 mm, height: 50.3 mm) having a bottom to obtain a case 1. The case used was a case formed from a nickel-plated steel plate. Next, the two positive electrode pellets were inserted into the case 1 in a longitudinal direction of the case 1 and then pressed to form a positive electrode 2 in intimate contact with an inner wall of the case 1. Next, a cylindrical separator 4 having a bottom was placed inside the positive electrode pellets. The separator 4 was composed of a cylindrical separator 4a and a bottom paper 4b. The cylindrical separator 4a and the bottom paper 4b were formed from a non-woven sheet obtained by mixing a rayon fiber and a polyvinyl alcohol fiber as main materials. The separator 4a was formed by winding the non-woven sheet three times.

Next, an electrolytic solution was poured into the case 1 to impregnate the separator 4 with the electrolytic solution. The same electrolytic solution as that used in the manufacture of the positive electrode pellets was used. The case 1 containing the electrolytic solution was left to stand for a predetermined period of time to let the electrolytic solution permeate the positive electrode 2 through the separator 4. Thereafter, the inner side of the separator 4 was filled with a predetermined amount of the gel negative electrode (negative electrode 3).

A negative electrode current collector 6 was obtained by forming common brass (Cu content: about 65% by mass, Zn content: about 35% by mass) into a nail shape through pressing and then plating a surface thereof with tin. A head portion of the negative electrode current collector 6 was electrically welded to a negative electrode terminal plate 7 formed from a nickel-plated steel plate. Thereafter, a body portion of the negative electrode current collector 6 was pressed into a through hole of a gasket 5 made of resin. Thus, a sealing unit 9 composed of the gasket 5, the negative electrode terminal plate 7, and the negative electrode current collector 6 was manufactured.

Next, the sealing unit 9 was placed at an opening of the case 1. At this time, the body portion of the negative electrode current collector 6 was inserted into the negative electrode 3. Next, an opening edge portion of the case 1 was swaged onto a peripheral edge portion of the negative electrode terminal plate 7 via the gasket 5 to seal the opening of the case 1. Next, an outer surface of the case 1 was covered with an exterior label 8. Thus, a battery A1 (alkaline dry battery) was manufactured.

### (Batteries A2 to A8 and X1 to X4)

A plurality of zinc alloy powders were manufactured using the same method as the manufacturing method described above in (2) other than that the manufacturing conditions were changed as shown in Table 1. The obtained zinc alloy powders were evaluated using methods described below.

A plurality of batteries (batteries A2 to A8 and X1 to X4) were manufactured using the same method as the manufacturing method of the battery A1 other than that the obtained zinc alloy powders were used as negative electrode active materials.

### (Evaluation of Zinc Alloy Powder)

### (1) Measurement of Apparent Density

The apparent density of each of the zinc alloy powders was measured using a gas displacement method in which helium gas was used. Specifically, the apparent density of each zinc alloy powder was measured using a helium pycnometer (AccuPyc1330) manufactured by Micromeritics Instrument Corporation.

### (2) Evaluation of Ratio Between First Through Third Particles

The manufactured zinc alloy powders were each classified using the following method. First, the zinc alloy powder was dispersed in a resin, and then the resin was cured to obtain a sample. Next, a cross section of the sample was exposed using the cross section polisher method. Next, an image of the exposed cross section was captured using a scanning microscope, and thus an image including 100 or more particles (particles having a maximum diameter of 10 μm or more in the cross-sectional image) that were evaluation targets was obtained.

100 particles having a maximum diameter of 10 μm or more were arbitrarily selected in the obtained image and evaluated to classify each of the 100 particles into any of the first through third particles in accordance with the above-described criteria. Then, the above-described ratio Na/Nb and the ratio between the numbers of the first through third particles were calculated from the evaluation result.

### (3) Evaluation of Average Particle Diameter

The average particle diameter (D50) of each of the manufactured zinc alloy powders was measured. The average particle diameter was obtained by measuring a particle size distribution on the volume basis in a dry dispersion method using Master sizer 3000 (manufactured by Malvern Panalytical Ltd.), which is a laser diffraction particle size distribution measuring device.

### (Evaluation of Batteries)

The manufactured batteries were each evaluated using the following method. First, an external short circuit was caused to take place between the positive electrode terminal and the negative electrode terminal of the battery with use of a nickel tab. At this time, a surface temperature of a center region of a side surface of the battery was monitored to determine the highest temperature T (° C.) during the short circuit.

Some of the manufacturing conditions of the zinc alloy powders, evaluation results of the powders, and evaluation results of the batteries are shown in Table 1. Note that the batteries A1 to A8 are alkaline dry batteries (A) according to the present disclosure, and X1 to X4 are batteries of comparative examples.

TABLE 1

| | | | | Ratio between numbers of zinc | | Zinc alloy powder | | Evaluation |
|---|---|---|---|---|---|---|---|---|
| | Powder manufacturing conditions | | | alloy powder particles | | Average | | of battery |
| | Dripping | Disc | Oxygen | | First | particle | | Highest |
| | rate | rotation | concentration | | particles:second | diameter | Apparent | temperature |
| | (kg/ | speed | (% by | Ratio | particles:third | D50 | density | T |
| Battery | minute) | (rpm) | volume) | Na/Nb | particles | (μm) | (g/cm³) | (° C.) |
| A1 | 1.1 | 10000 | 10 | 10/90 | 10:86:4 | 90 | 6.980 | 93 |
| A2 | 1.1 | 10000 | 15 | 30/70 | 29:67:4 | 110 | 6.990 | 89 |
| A3 | 1.2 | 10000 | 10 | 45/55 | 43:53:4 | 105 | 7.010 | 83 |
| A4 | 1.2 | 15000 | 15 | 75/25 | 72:24:4 | 120 | 7.045 | 86 |
| A5 | 1.3 | 15000 | 15 | 90/10 | 86:10:4 | 125 | 7.050 | 90 |
| A6 | 1.3 | 12000 | 10 | 50/50 | 40:40:20 | 110 | 7.030 | 84 |
| A7 | 1.2 | 13000 | 12 | 56/44 | 50:40:10 | 107 | 7.020 | 81 |
| A8 | 1.2 | 14000 | 14 | 66/34 | 57:29:14 | 112 | 7.030 | 82 |
| X1 | 1.1 | 10000 | 0 | 0/100 | 0:4:96 | 40 | 7.065 | 98 |
| X2 | 1.1 | 10000 | 5 | 7/93 | 7:89:4 | 66 | 6.975 | 99 |
| X3 | 1.3 | 15000 | 18 | 93/7 | 89:7:4 | 128 | 7.053 | 100 |
| X4 | 1.3 | 15000 | 20 | 100/0 | 96:0:4 | 130 | 7.055 | 101 |

As shown in Table 1, the highest temperature T during the external short circuit was significantly low in the batteries A1 to A8 according to the present disclosure. As shown in Table 1, when the apparent density of the zinc alloy powder was within the range from 6.980 to 7.050 g/cm³, a temperature increase of the battery due to the occurrence of an external short circuit was suppressed.

### INDUSTRIAL APPLICABILITY

The present disclosure is applicable to alkaline dry batteries.

Although currently preferred embodiments of the present invention have been described, this disclosure should not be interpreted as limiting the present invention. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the invention.

### REFERENCE SIGNS LIST

1: battery case, 2: positive electrode, 3: negative electrode, 4: separator, 5: gasket, 9: sealing unit, 10: alkaline dry battery

1. An alkaline dry battery comprising:
a positive electrode;
a negative electrode; and
a separator disposed between the positive electrode and the negative electrode,
wherein the negative electrode contains a zinc alloy powder,
the zinc alloy powder contains first zinc alloy particles, second zinc alloy particles, and third zinc alloy particles,
in a cross-sectional image of the zinc alloy powder,
the first zinc alloy particles each include a specific hole,
the second zinc alloy particles each do not include the specific hole but include a specific closed void therein,
the third zinc alloy particles each do not include the specific hole and the specific closed void therein,
the specific hole is a hole for which a ratio D/W between a straight-line distance D from an opening to a bottom surface and a width W of the opening is 1.0 or more, and the straight-line distance D is 2 μm or more, and
the specific closed void has a minor axis length of 2 μm or more, and
the zinc alloy powder has an apparent density within a range from 6.980 to 7.050 g/cm³.

2. The alkaline dry battery according to claim 1,
wherein the apparent density of the zinc alloy powder is within a range from 7.010 to 7.045 g/cm³.
